(19) United States
(12) Patent Application Publication
(10) Pub. No.: US 2020/0269533 A1
(43) Pub. Date: Aug. 27, 2020

(54) DRUM FOR BUILDING AND SHAPING A TIRE CARCASS

(71) Applicant: COMPAGNIE GENERALE DES ETABLISSEMENTS MICHELIN, CLERMONT-FERRAND (FR)

(72) Inventors: HENRI HINC, Clermont-Ferrand (FR); JEAN-MARIE DETTORRE, Clermont-Ferrand (FR)

(21) Appl. No.: 15/781,609

(22) PCT Filed: Dec. 15, 2016
(86) PCT No.: PCT/FR2016/053465

§ 371 Date: Jun. 5, 2018

(30) Foreign Application Priority Data
Dec. 18, 2015 (FR) 1562845

(51) Int. Cl. B29D 30/24

(52) U.S. Cl. CPC B29D 30/245; B29D 2030/2642

(57) ABSTRACT

This drum (1000) for building and shaping a tire carcass, comprises:
a surface (1106, 1506, 1206) for building a tire carcass of cylindrical overall shape having a main axis of rotation,
first and second movable supports of the surface,
members (1980, 1600, 1400, 1450) for adjusting a diameter of the surface,
members for adjusting an axial distance between the first and second supports.

It further comprises first means (1700, 1800) of sealed connection between the surface and at least one of the first or second supports, and second means of sealed connection between the first and second supports.

The invention lies in the technical field of tire manufacture. It relates in particular to the building and shaping of a tire carcass.

According to a known method, the manufacture of a green tire chiefly comprises two steps.

The first step corresponds to the building of the carcass of the future tire. This carcass generally comprises one or more sealing layers, one or more carcass plies, two circular bead wires, and various other rubber products intended for example to reinforce the sidewalls and the lower sidewalls of the future tire. These elements are assembled flat, one on top of another, on a drum referred to as a tire building drum. On this tire building drum, the carcass made up of the assembly of these various elements is cylindrical in shape. At the end of this first step, ply turning is usually performed and this consists in turning the ends of the carcass around the bead wires.

The second step corresponds to finishing. First of all, shaping is performed which involves transforming the carcass from a cylindrical shape to the toric shape of the future tire. In order to do this, the carcass is mounted on what is referred to as a “finishing” or “shaping” drum that allows the carcass to be inflated, for example with a stream of air, and at the same time allows the distance between the bead wires of the carcass and referred to as the “bead wire separation” to be reduced. Secondly, once the carcass has been shaped, the components of the crown of the future tire are assembled on the shaped carcass. These components notably comprise one or more crown plies and the tread of the future tire. These components may be assembled one after the other directly on the shaped carcass. As an alternative, these components are preassembled on a cylindrical form and this pre-assembly is then transferred onto the shaped carcass using a transfer ring.

Once the crown components are assembled with the toroidal carcass, the green tire is ready to be placed in a curing mould where the various rubbery components of the future tire will be vulcanized. The vulcanization step makes it possible to achieve the finished tire.

The present invention is more particularly concerned with the building of the carcass and with the shaping of this carcass so as to finish the green tire. These steps are generally performed on respective tire building and tire finishing drums, the diameters of which preferably correspond substantially to the diameter, at a bead formed by ply-turning, of the future tire, this also being known as the “diameter at the seat”. This also corresponds to the interior diameter of the tire or, in other words, to the diameter of the rim of the future wheel comprising the tire. In what follows, this dimension will be referred to only as the diameter of the tire. Various types of tire may have various diameters, various crown widths, various sidewall heights and therefore various bead wire separations. In point of fact, each tire building drum and each tire finishing drum is generally used for the manufacture of a green tire of a single given diameter. As a result, in order to manufacture tires of different diameters it is necessary to design, manufacture, store and maintain a plurality of tire building drums and a plurality of tire finishing drums

A drum capable of being used both for building and for shaping a tire carcass is already known in the prior art, particularly from EP1674249, but this too is suitable for only a single type of tire. It has means of adjusting the diameter, but these adjusting means allow only a slight modification of the diameter of the tire in the central part thereof. Specifically, these adjusting means allow the diameter of the central part of the tire to be extended slightly for the purpose of the manufacture of the lower sidewall portion of the future tire in the region of the bead wires, or allow this central part to be retracted slightly so that the green tire can be extracted. The drum is therefore suitable only for a given diameter of tire. The means for adjusting the bead wire separation allow this distance to be varied only for shaping the green tire, but do not allow the building of carcasses comprising different bead wire separations. The carcass is shaped by blowing air.

Thus, the drum described in EP1674249 merely halves the number of drums needed for building and finishing tires. For each tire having a specific diameter and/or a specific bead wire separation, a different drum has to be used.

It is an object of the invention to limit the number of drums needed for manufacturing tires with different diameters and different bead wire separations.

To this end, the invention provides a drum for building and shaping a tire carcass, comprising:

a surface for building a tire carcass of cylindrical overall shape having a main axis of rotation,

first and second movable supports of the surface,

members for adjusting a diameter of the surface,

members for adjusting an axial distance between the first and second supports, further comprising first means of sealed connection between the surface and at least one of the first or second supports, and second means of sealed connection between the first and second supports.

Thus, the first and second means of sealed connection make it possible in part to delimit an air chamber that allows the carcass to be shaped by blowing the central part thereof using the air of the air chamber. In the invention, the members for adjusting the diameter allow the drum to be adapted to suit the various diameters of tire that are to be manufactured. Furthermore, the members for adjusting the axial distance between the first and second supports allow the drum to be adapted to suit the bead wire separation of the tire that is to be manufactured. Thus, this drum can be adapted to manufacture various types of tires having different diameters at the seat and different crown widths (and therefore different bead wire separations). In addition it allows both the building and the shaping of the carcass. The number of drums to be manufactured, stored and maintained is therefore considerably reduced.

Advantageously, the drum comprises first and second sets of end segments forming end parts of the surface, each segment of the first set being mounted with the ability to move in the radial direction on the first support, the first support being common to the segments of the first set, each segment of the second set being mounted with the ability to move in the radial direction on the second support, the second support being common to the segments of the second set. Thus, the end segments support the tire carcass and their adjustable radial position allows the diameter of the surface of the drum to be adjusted so as to adapt it to suit the diameter of the tire that is to be manufactured.

For preference, the first means of sealed connection comprise at least one radial sealing membrane that is elastically deformable in the radial direction according to an adjustment of the diameter of the surface, the membrane connecting the end segments of one of the sets of end segments in a sealed manner to the support which is common to the end segments of this set. Thus, the membrane adapts to the adjustment of the diameter of the surface of the drum and performs its sealing function for any diameter.

Advantageously, the membrane comprises annular pleats forming a gaiter and radial pleats distributed around the annular pleats and extending right out to a periphery of the membrane. Thus, the annular pleats allow the membrane to be stretched radially while the radial pleats allow the perimeter of the membrane to extend as a function of the radial expansion thereof.

For preference, the second means of sealed connection comprise an axial sealing member deformable in the axial direction according to an adjustment of the distance between the first and second supports and connecting the first and second supports in a sealed manner. Thus, the axial sealing member makes it possible at least in part to achieve the sealing needed for shaping the green tire while at the same time adapting to the adjustment of the bead wire separation relating to the width of the tire that is to be manufactured.

Advantageously, the axial sealing member comprises telescopic tubes sliding axially with respect to one another according to the adjustment of the distance between the first and second supports.

For preference, the members for adjusting the distance between the first and second supports and the members for adjusting the diameter of the surface each comprise an endless screw, the two screws extending axially through the axial sealing member. Thus, the endless screws make it possible, independently of one another, to adjust the diameter of the surface and the bead wire separation of the drum and thus to adapt it to suit the dimensions of the tire that is to be manufactured.

Advantageously, the members for adjusting the diameter of the surface comprise first and second cam profiles intended to collaborate respectively with first and second members that follow these profiles and are borne respectively by the first and second sets of end segments, the first and second cam profiles being borne respectively by first and second cams, the two cams being able to move in a direction parallel to the axis, the first and second cam profiles respectively converting a movement of the first and second cams into a radial movement of the first and second sets of an end segment respectively. Thus, the two cams operate symmetrically and, depending on their axial position, make it possible to adjust the diameter of the surface of the drum. For preference, the members for adjusting the distance between the first and second supports comprise members effecting the relative axial movement of the first and second supports.

Advantageously, the drum further comprises a set of central segments forming a central part of the surface, each central segment being borne by at least one axial rod mounted with the ability to slide on two end segments. Thus, when the bead wire separation of the drum varies, i.e. when the distance between the first and second supports varies, the end segments move by sliding at the level of the rod, and notably on either side of each central segment, whereas each central segment remains in the same position with respect to the rod. When the diameter of the surface varies, the set of central and end segments moves radially in a synchronous manner.

For preference, the membrane has at least one orifice for the passage of the axial rod. Thus, the membrane follows the end segments to which it is connected as they move, by sliding relative to the axial rod.

Advantageously, the first and second sets of end segments respectively bear first and second annular grooves for the respective positioning of the first and second bead wires. Thus, the grooves allow the bead wires of the carcass to be positioned on the drum. The bead wire separation therefore corresponds substantially to the distance between these grooves and can vary from one tire to another.

For preference, within one of the sets of end segments, two circumferentially adjacent segments have complementary edges with teeth and notches. Thus, when the diameter of the surface of the drum increases, the circumferentially adjacent segments move apart. However, because the shape of the separation between the segments involves notches, no axial rectilinear rupture is caused within the surface of the drum, and this means that there is only a limited risk of the carcass being nipped on the surface of the drum when the diameter of the surface increases.

A non-limiting embodiment of the invention will now be described by way of example with reference to the appended drawings, in which:

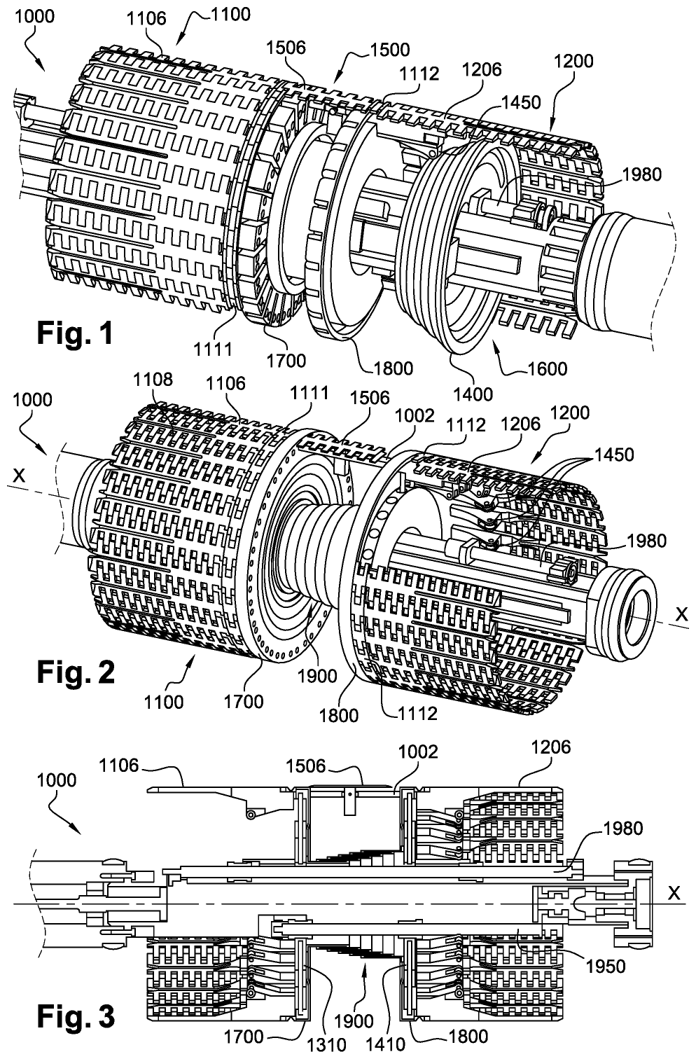

FIG. 1 is a perspective view of a drum according to the invention, the bead wire separation and the diameter being contracted;

FIG. 2 is a view of the same drum, the bead wire separation and the diameter being expanded;

FIG. 3 is a view in longitudinal median section of the drum of FIG. 2;

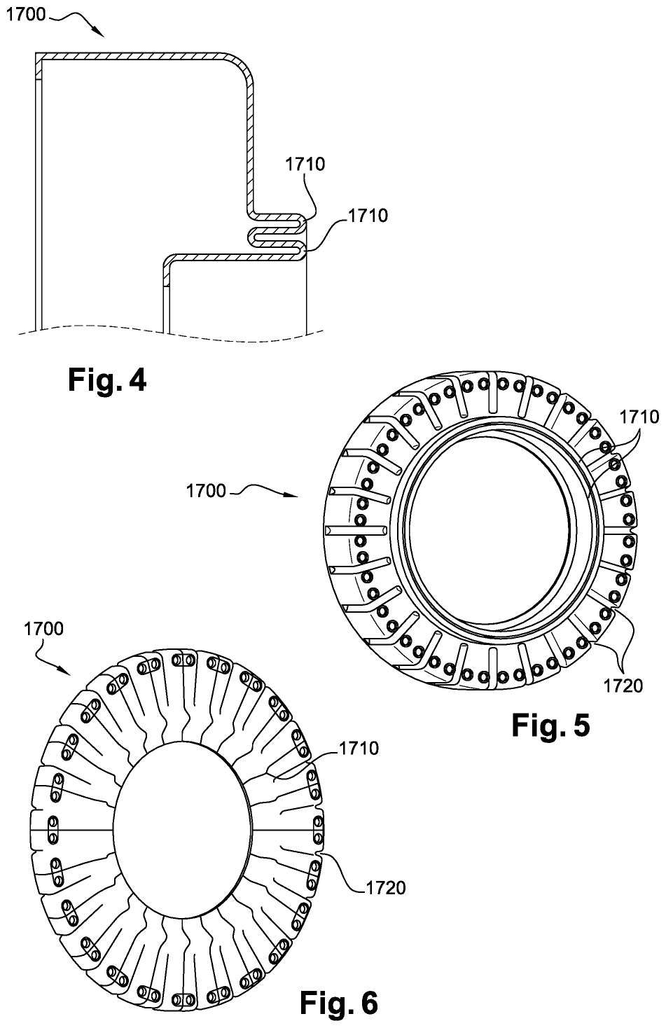

FIGS. 4, 5 and 6 are views of a membrane according to the invention, in median section and in perspective with the membrane retracted, and in perspective when the membrane has been expanded respectively;

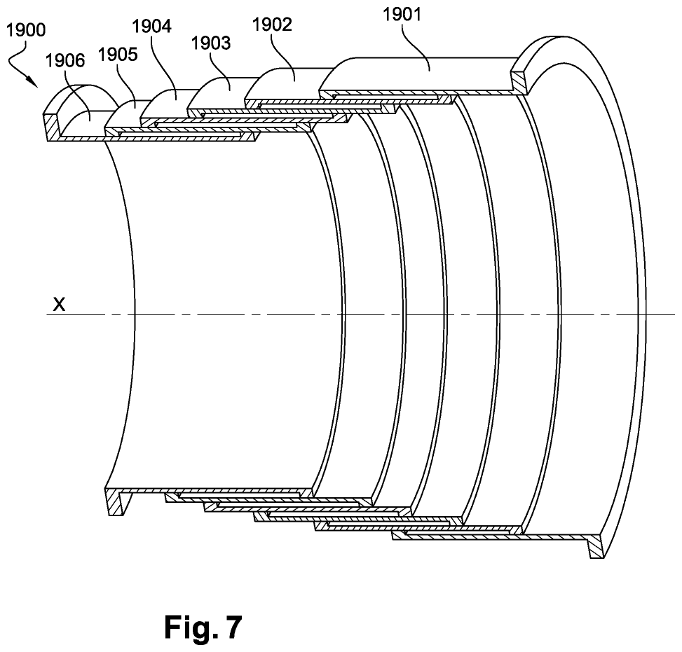

FIG. 7 is a view in longitudinal axial section of an axial sealing member according to the invention;

FIGS. 8, 9 and 10 are diagrams illustrating steps in a method for building and shaping a tire carcass according to the invention.

In what follows, a tire in a cylindrical state prior to shaping will be referred to as a carcass, and a tire that has been shaped but not yet cured will be referred to as a green tire. The green tire is thus the result of a built and shaped carcass on which the crown forms have been laid.

FIGS. 1 to 3 illustrate a drum 1000 for building and shaping a tire carcass according to the invention. It comprises first and second sets 1100 and 1200 of end segments, the set 1100 notably comprising a segment 1106 and the set 1200 a segment 1206. These sets of segments 1100 and 1200 form end parts of a surface for building a tire carcass of cylindrical overall shape having a main axis of rotation X, referenced in FIGS. 2 and 3. Each end segment of the first set 1100 is mounted with the ability to move in the radial direction, with respect to the axis X, on a first axially movable support 1310 common to the segments of the first set 1100. The support 1310 visible in FIG. 3 has a cylindrical overall shape. Likewise, each end segment of the second set 1200 is mounted with the ability to move in the radial direction on a second axially movable support 1410 common to the segments of the second set 1200.

The drum 1000 further comprises a set 1500 of central segments, notably comprising a central segment 1506 forming a central part of the surface of the drum 1000. Each central segment is borne by at least one axial rod mounted with the ability to slide on two end segments. Thus, the central segment 1506 is borne by the rod 1002 mounted with the ability to slide on the two end segments 1106 and 1206

Within one of the sets of end segments, for example within the set 1100, all the circumferentially adjacent segments, notably the segments 1106 and 1108 illustrated in FIG. 2, have complementary edges with teeth and notches. This shape of the edges of the segments offers the following advantage: as the diameter of the surface of the drum 1000 increases, the segments move apart from one another in the circumferential direction. In point of fact, if the segments had rectilinear edges, the moving-apart of the segments word generate rectilinear ruptures along the surface of the drum, between each segment. The carcass laid on the drum could then be nipped in this type of rupture. Here, thanks to the teeth and notches, ruptures in the axial direction are intermittent, so that there is far less of a risk of the carcass being nipped.

The first and second sets of end segments 1100 and 1200 respectively bear first and second annular grooves 1111 and 1112 for positioning the first and second bead wires of the carcass, respectively. These grooves are removable so that for a given diameter of the surface of the drum there is a suitable pair of grooves that can be replaced with another pair when the diameter of the surface changes for manufacturing a tire of a different diameter. As an alternative, it is possible not to use grooves. Indeed it is possible, for example, to compress the bead wires between the carcass and the surface of the drum.

The surface of the drum 1000 may change in diameter in order to adapt to several types of tire that are to be manufactured, each tire being able to have a different diameter. As stated above, it is the diameter at the bead of the finished tire, corresponding substantially to the rim diameter of the future vehicle wheel, that is referred to as “diameter”. This is also referred to as the “diameter at the seat”. It furthermore corresponds to the diameter of the carcass in the cylindrical state.

The way in which the diameter of the surface of the drum is modified will now be explained. In what follows, the diameter of the drum or the diameter of the surface will be used interchangeably.

The members for adjusting the diameter of the drum comprise first and second cam profiles. One of these cam profiles, 1400, is visible in FIG. 1, the other being positioned symmetrically in relation to the set 1100 and not illustrated. Everything regarding the profile 1400 is valid for the symmetrical profile.

The cam profile 1400 exhibits symmetry of revolution about the main axis X of rotation of the drum and comprises several levels of diameter, which evolve in an axial direction. These levels of diameter make it possible to adjust the diameter of the surface of the drum. Specifically, these first and second cam profiles are intended to collaborate respectively with first and second cam profile follower members, only one 1450 of these members being visible. These are borne respectively by the first 1100 and second 1200 sets of end segments. These members and notably the member 1450 comprise a series of rollers able to roll over the cam profiles. These rollers are visible in FIGS. 1 to 3. Thus, for example, as the rollers move from one diameter of cam profile 1400 to another, the end segment 1206, borne by one of the rollers, changes radial position. Because the rollers of the member 1450 are distributed in a circle around the cam profile 1400, all the end segments of the set 1200 move synchronously in the radial direction. The same is true of the segments of the set 1100. It is in this way that the diameter of the drum 1000 evolves.

The first and second cam profiles are borne respectively by first and second cams, notably the cam 1600 visible in FIG. 2 which bears the profile 1400. The two cams are able to move in a direction parallel to the main axis X of the drum. The cams operate in synchronism and move symmetrically, either closer towards the central part of the drum or away therefrom. This movement causes the first and second members, notably the member 1450, to roll over the cam profiles. Because the diameter of the profiles evolves along the axis X when the cams move axially, the rollers and therefore the end segments supported by the rollers move radially. Thus, the first and second cam profiles respectively convert a movement of the first and second cams into a radial movement of the first and second sets of end segments 1100 and 1200, respectively.

In order to be moved, the cams are fixed to an endless screw 1980, visible in FIGS. 1 to 3. The cams move in one direction or the other along the axis X according to the rotation of the screw 1980. It is the movements of the cams which are caused by the rotation of the screw 1980 that therefore allow the diameter of the drum to be modified.

The drum is also able to adapt to the distance between the bead wires of the carcass that is to be built and shaped. This distance between the bead wires, also referred to in what follows as the “bead wire separation”, corresponds to the distance between the bead wires of the future tire.

The way in which the bead wire separation is modified will now be described.

The members for adjusting the bead wire separation move the two supports 1310 and 1410 axially according to the rotation of an endless screw 1950 visible in FIG. 3. The two supports move further away from one another or closer towards one another according to the rotation of the screw 1950. As a result, the end segments common to these supports likewise move closer towards or further away from one another. Thus, the end supports 1106 and 1206 move further away from the central segment 1506 according to the rotation of the screw 1950. Because the annular grooves 1111 and 1112 are positioned on either side of the central segments, on the end segments, they move closer towards or further away from one another, causing the bead wire separation to vary. Thus, the drum 1000 can be adapted to several bead wire separations, according to the dimensions of the tire that is to be manufactured.

It is necessary for the diameter of the drum and the bead wire separation to be adjusted simultaneously. Specifically, when for example the supports 1310 and 1410 are moved closer towards one another via the screw 1950 without altering the diameter setting, the members 1450 roll along cam profiles which are fixed, and the diameter of the drum changes. Conversely, if the screw 1980 is used to modify the diameter, with no action on the screw 1950, then the bead wire separation will also vary. It is therefore necessary to operate the two adjusting screws 1950 and 1980 simultaneously and synchronously if one of the dimensions is to be modified without modifying the other.

The members for adjusting the bead wire separation and the members for adjusting the diameter of the drum therefore each comprise an endless screw. These two screws 1950 and 1980 extend axially through a sealing member 1900 described later on. The members for adjusting the bead wire separation may also comprise members for effecting the relative axial movement of the first and second supports 1310 and 1410, these members for example taking the form of pneumatic or electric actuators or any other mechanical system able to afford the requisite positional accuracy.

The drum 1000 is able to perform the shaping of the green tire. To this end it comprises means of sealed connection in part forming an air chamber that is also delimited by the carcass. Specifically, shaping is performed by blowing air from the air chamber towards the central part of the carcass, while the bead wire separation is reduced using a method described later on.

First means of sealed connection between the surface and the supports 1310 and 1410 comprise two radial sealing membranes 1700 and 1800 which are elastically deformable in the radial direction according to the drum diameter setting. These membranes are identical and have a cylindrical shape. They are made from an elastomer material which may be reinforced with textile or metallic materials. They are situated on either side of the central part of the drum 1000. The membrane 1700 connects the end segments of the set 1100 of end segments in a sealed manner to the first support 1310 which is common to the end segments of this set. The membrane 1800 connects the end segments of the set 1200 of end segments in a sealed manner to the second support 1410 which is common to the end segments of this set. In what follows, it is the membrane 1700 that will be described, all the features being de facto the same for the membrane 1800.

The membrane 1700, illustrated in greater detail in FIGS. 4 to 7, comprises annular pleats 1710 forming a gaiter and radial pleats 1720 distributed around the annular pleats and extending right out to a periphery of the membrane 1700. These pleats 1710 and 1720 allow the membrane to be adapted in terms of radial and circumferential expansion according to the adjustment in diameter of the surface of the drum 1000. Specifically, when the diameter of the surface increases, the membrane is able to increase in diameter likewise, thanks to the annular pleats 1710. Because the diameter is increasing, the perimeter of the membrane also has to increase, and that is achieved by means of the radial pleats 1720. These pleats 1710 and 1720 therefore act as a reserve of material so as to allow the membrane to be adapted to the diameter of the drum. Furthermore, each membrane has orifices for the passage of the axial rods 1002. The membranes therefore slide on these rods as the bead wire separation varies. The membranes of FIGS. 1, 4 and 5 are in a retracted position whereas the membranes in FIGS. 2, 3 and 6 are, in this instance, radially extended. The membranes therefore make it possible to seal part of an air chamber, and to do so for all dimensions of the drum 1000, notably regardless of the diameter of the surface. Another part of the sealing of the air chamber is afforded by the carcass, whereas the final part of the sealing is achieved by second means of sealed connection between the first and second supports 1310 and 1410.

These second means of sealed connection comprise an axial sealing member 1900, illustrated in detail in FIG. 7. It is deformable in the direction of the axis X, according to the bead wire separation setting. It connects the first and second supports 1310 and 1410 in a sealed manner. It comprises six telescopic tubes 1901 to 1906 sliding axially relative to one another according to the bead wire separation setting. The number of telescopic tubes may of course vary. It is these slidings that allow the member 1900 to deform in the axial direction. This member associated with the two membranes 1700 and 1800 and with the carcass therefore seals the air chamber, allowing the step of shaping the green tire to be performed. In addition, thanks to the telescopic tubes and therefore to its axial deformation, it adapts to the bead wire separation of the carcass which changes according to the distance between bead wires of the green tire that is to be manufactured, according to the width of the crown of the future tire and according to the height of the sidewalls of the future tire.

Thus, the membranes 1700 and 1800 and the member 1900 allow the hair chamber to be sealed, and to do so for various diameters and various bead wire separations of the carcass that is to be built and shaped

One method for building and shaping a tire carcass according to the invention will now be described with reference to the diagrams of FIGS. 8 to 10.

FIGS. 8 to 10 again show the membranes 1700 and 1800, the supports 1310 and 1410, the cam profile 1400 (and its symmetrical counterpart on the other side of the drum), the axial sealing member 1900 and the surface of the drum 1000 formed notably by the end segments 1106 and 1206 and by one of the central segments 1506. The axial rod 1002, supporting the central segment 1506 and sliding through the membranes 1700 and 1800 and the end segments 1100 and 1200, is also schematically indicated.

The first step is the building of the carcass. The carcass 2 is placed on the surface of the drum. It comprises first rubber products, one or more inner liners, carcass threads and possibly other products. One or several rollering operations may be performed on the surface so as to cause the layers of the carcass to bond to one another. Rollering involves rotating the drum while rollers apply pressure to the various layers of the carcass laid one after the other. The result is therefore schematically illustrated in FIG. 8, the carcass at that moment being cylindrical in shape.

The building of the carcass also involves the placement of bead wires. To this end, the drum 1000 has grooves 1111 and 1112 which are situated under the central tile 1506 when the bead wire separation of the drum is at its minimum. What is meant by the bead wire separation of the drum is the distance between the supports 1310 and 1410. This is what has been illustrated in FIG. 8. In order to place the bead wires, the distance between bead wires is increased by turning the endless screw 1950 in the direction that allows the supports 1310 and 1410 to be moved away from one another. In synchronism with this, the diameter is adjusted by means of the screw 1980 so that it remains stable. The grooves 1111 and 1112 which were positioned under the central tile are then accessible, and the bead wires are placed therein.

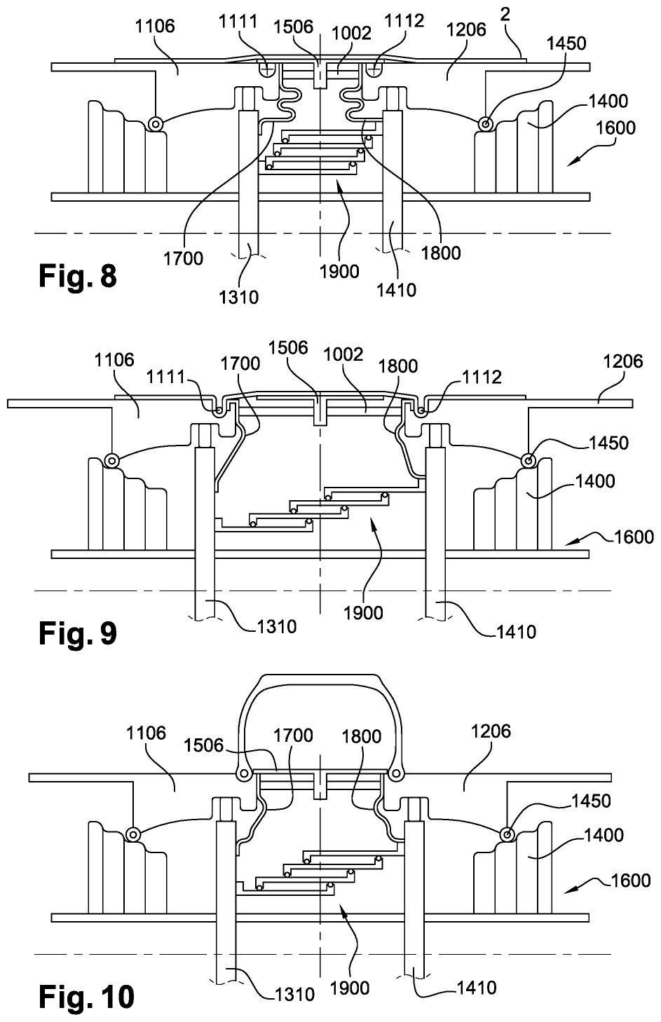

In order to insert the bead wires into the grooves and to settle them therein as deeply as possible, the diameter of the drum is increased slightly while maintaining the bead wire separation. This then results in the arrangement of FIG. 9. In order to increase the diameter of the drum, it is necessary to turn the endless screw 1980 such a way as to move the cams. Considering only the cam 1600 (the symmetrical cam operates in a synchronous manner), this moves closer to the central part of the drum. The roller 1450 is therefore moved radially as it travels over the cam profile 1400. That allows the segment 1206 supported by the roller 1450 to be moved radially. Because the two cams work symmetrically in the same way all the end segments move in a synchronous manner. The central segments are pressed against the rods 1002, which slide in the end segments. These central segments are kept at the centre of the rods by a spring mechanism for example. The central segments therefore move radially also in the same way as the end segments when the endless screw 1980 turns. At the same time, there is an action on the screw 1950 so as to maintain the bead wire separation. Specifically, as the cams approach the central part, the supports 1310 and 1410 do so also. It is therefore necessary, in order to maintain the bead wire separation, to compensate for this closing-together by moving them further away from one another using the screw 1980. In FIG. 8, the carcass has been laid and the bead wires are sitting deeply in the grooves as a result of the slight increase in diameter of the drum 1000. The carcass is therefore built.

The second step is to shape the carcass. This involves converting its cylindrical shape into a toroidal shape, that of the future tire that it is intended to become. To this end, the bead wire separation is closed up by turning the endless screw 1950 in the direction that allows the supports 1310 and 1410 to be moved closer towards one another. There is also an action on the screw 1980 so as to move the cams further away from one another in order to maintain the diameter of the surface as the bead wire separation reduces. During this reduction, air is circulated in the central part of the carcass, situated between the bead wires, so as to inflate this part. The means of supplying the air are not illustrated here and can be embodied by any known means. However, it is necessary for the air pressure to be applied between the bead wires of the green tire and towards the inside of the green tire. In order to avoid air leaks, a region forming an air chamber is delimited by the membranes 1700 and 1800, by the axial sealing member 1900 and by the carcass itself. What is meant by sealing is, in reality, that the leakage flow rate is negligible in comparison with the air flow rate needed to shape the green tire.

Thus, the green tire adopts a toroidal shape, as illustrated in FIG. 10.

Throughout the changes in diameter of the drum, the first means of sealed connection between the surface and the movable supports 1310 and 1410, comprising the sealing membranes 1700 and 1800, are able to maintain the sealing of the air chamber, because they are radially deformable. Likewise, during the changes in bead wire separation, the second means of sealed connection between the movable supports 1310 and 1410, comprising the member 1900, are able to maintain the sealing of the air chamber, because the member 1900 can deform axially by means of its telescopic elements.

On completion of the shaping step, a tread previously prepared on another drum can be applied to the carcass which has been shaped and is still in place on the drum 1000. This then yields the green tire.

In order to extract the green tire from the drum 1000, the diameter of the surface of the drum 1000 is reduced. It is then possible to remove the green tire in order to move on to the vulcanizing (also referred to as “curing”) step which will allow the green tire to be converted into a finished tire.

In summary, the invention has presented a drum 1000 for building and shaping a tire carcass, comprising:

a surface, notably comprising the segments 1106, 1506, 1206, for building a tire carcass of cylindrical overall shape having a main axis of rotation X,

first and second movable supports 1310 and 1410 of the surface,

members (the endless screw 1980, the cam 1600, the cam profile 1400, the member 1450) for adjusting a diameter of the surface,

members (the endless grew 1950) for adjusting an axial distance between the first and second supports 1310 and 1410,

further comprising first means of sealed connection between the surface and at least one of the first or second supports 1310 and 1410, comprising the membranes 1700 and 1800, and second means of sealed connection between the first and second supports 1310 and 1410, comprising the axial sealing member 1900.

Of course, numerous modifications may be made to the invention without departing from the scope thereof.

1-13. (canceled)

14: A drum for building and shaping a tire carcass, the drum comprising:
a surface having an overall cylindrical shape with a main axis of rotation, the surface being structured to support a tire carcass being built;
first and second movable support members structured to support the surface;
radial adjustment members structured to adjust a diameter of the surface;
axial adjustment members structured to adjust an axial distance between the first and second movable support members;
a first sealing connector structured to sealingly connect the surface and at least one of the first and second movable support members; and
a second sealing connector structured to sealingly connect the first and second movable support members.

15: The drum according to claim 14, further comprising:
a set of first end segments forming a first end part of the surface, each first end segment being mounted for movement in a radial direction on the first movable support member; and
a set of second end segments forming a second end part of the surface, each second end segment being mounted for movement in the radial direction on the second movable support member.

16: The drum according to claim 14, wherein the first sealing connector includes at least one radial sealing membrane, each radial sealing membrane being elastically deformable in the radial direction according to an adjustment of the diameter of the surface, and each radial sealing membrane connecting the set of first end segments to the first movable support member or connecting the set of second end segments to the second movable support member.

17: The drum according to claim 16, wherein each radial sealing membrane includes:
annular pleats forming a gaiter, and
radial pleats distributed around the annular pleats and extending out to a periphery of the radial sealing membrane.

18: The drum according to claim 14, wherein the second sealing connector includes an axial sealing member that is deformable in an axial direction according to an adjustment of the axial distance between the first and second movable support members, the axial sealing member connecting the first and second movable support members in a sealed manner.

19: The drum according to claim 18, wherein the axial sealing member includes telescopic tubes that are structured to slide axially with respect to one another according to the adjustment of the axial distance between the first and second movable support members.

20: The drum according to claim 18,
wherein the axial adjustment members include a first endless screw arranged to adjust the axial distance between the first and second movable support members,
wherein the radial adjustment members include a second endless screw arranged to adjust the diameter of the surface, and
wherein the first and second endless screws extend axially through the axial sealing member.

21: The drum according to claim 15,
wherein the radial adjustment members include first and second cam profiles structured to collaborate respectively with first and second follower members structured to follow the first and second cam profiles,
wherein the first and second follower members are borne respectively by the set of first end segments and the set of second end segments,
wherein the first and second cam profiles are borne respectively by first and second cams that are movable in a direction parallel to the main axis of rotation,
wherein the first and second cam profiles are structured to convert, respectively, movements of the first and second cams into respective radial movements of the set of first end segments and the set of second end segments.

22: The drum according to claim 14, wherein the axial adjustment members are structured to effect a relative axial movement of the first and second movable support members.

23: The drum according to claim 15, further comprising a set of central segments structured to form a central part of the surface, each central segment being borne by at least one axial rod movably mounted to slide on a corresponding first end segment and a corresponding second end segment.

24: The drum according to claim 23,
wherein the first sealing connector includes at least one radial sealing membrane, each radial sealing membrane being elastically deformable in the radial direction according to an adjustment of the diameter of the surface, and each radial sealing membrane connecting the set of first end segments to the first movable support member or connecting the set of second end segments to the second movable support member, and
wherein each radial sealing membrane includes at least one orifice structured to receive the at least one axial rod.

25: The drum according to claim 15,
wherein the set of first end segments bears a first annular groove structured to position a first bead wire therein, and
wherein the set of second end segments bears a second annular groove structured to position a second bead wire therein.

26: The drum according to claim 15, wherein two circumferentially adjacent first end segments or two circumferentially adjacent second end segments have complementary edges with teeth and notches.
